(19) United States
(12) Patent Application Publication
(10) Pub. No.: US 2019/0330100 A1
(43) Pub. Date: Oct. 31, 2019

(54) SOLAR CONTROL WINDOW FILM

(71) Applicant: SAINT-GOBAIN PERFORMANCE PLASTICS CORPORATION, Solon, OH (US)

(72) Inventors: Jia-Mei SOON, L'hay les Roses (FR); Yemima Anne BON SAINT COME, Hahira, GA (US); Laura J. SINGH, Paris (FR); Virginie MOREAU, Compiègne (FR); Antoine DIGUET, Paris (FR); Camille JOSEPH, Nantes (FR)

(21) Appl. No.: 16/343,082

(22) PCT Filed: Oct. 17, 2017
(86) PCT No.: PCT/US2017/056869

§ 371 Date: Apr. 18, 2019

Related U.S. Application Data
(60) Provisional application No. 62/410,979, filed on Oct. 21, 2016.

(51) Int. Cl. C03C 17/36; B32B 17/10

(52) U.S. Cl. CPC C03C 17/366; B60J 3/007; B32B 17/10779; C03C 17/3626; C03C 17/3644; C03C 17/3642; C03C 17/3649; C03C 17/3681; B32B 2255/205; B32B 2255/28; B32B 2605/006; C03C 2218/156; C03C 2217/228; C03C 2217/255; C03C 2217/256; C03C 2217/281; B32B 17/10036

(57) ABSTRACT

A composite window film may include a first window facing substrate, a reflecting stack and an absorbing stack. The reflecting stack may be located between the first window facing substrate and the absorbing stack. The composite window film may have a VLT not greater than about 80%, a TSER of at least about 40%, and an Energetic Absorption (EA) of not greater than about 50%.

### TECHNICAL FIELD

The present disclosure relates to a solar control window film. In particular, the present disclosure relates to a solar control window film having particular solar energy characteristics.

### BACKGROUND ART

Composite window films can be used as coverings applied to windows in building or vehicles to control the passage of solar radiation through transmission, reflection, and absorption. For certain composite window films, visible light transmittance and reflectance must be low and the total solar energy rejection must be high. This combination of features is of great importance for particular systems. As such, a need exists for composite films which have superior combined visible light transmittance, visible light reflectance, and total solar energy rejection properties at the desired levels.

### SUMMARY

According to one aspect, a composite window film may include a first window facing substrate, a reflecting stack and an absorbing stack. The reflecting stack may be located between the first window facing substrate and the absorbing stack. The composite window film may have a VLT not greater than about 80%, a TSER of at least about 40%, and an Energetic Absorption (EA) of not greater than about 50%.

According to still another aspect, a composite window film may include a first substrate, a pressure sensitive adhesive layer, a reflecting stack and an absorbing stack. The first substrate may have a first surface and a second surface opposite of and spaced away from the first surface. The pressure sensitive adhesive layer may be disposed on the first surface of the first substrate. The reflecting stack may include a functional layer that may include silver, gold, aluminum, copper, stainless steel, alloys thereof or combinations thereof. The absorbing stack may include an absorber layer that may include a metal nitride, a transparent conductive oxide (TCO), Nb, NbN, NiCrN, MoN, NiₓCR_{y}Nb_{z}, NiₓCR_{y}Nb_{z}N_{α}, GZO or AZO. The first substrate may be located between the pressure sensitive adhesive layer and the reflecting stack. The reflecting stack may be located between the first substrate and the absorbing stack.

According to yet another aspect, the composite window film may include a first substrate, a reflecting stack and an absorbing stack. The reflecting stack may include a functional layer that may include silver, gold, aluminum, copper, stainless steel, alloys thereof or combinations thereof. The absorbing stack may include an absorber layer that may include a metal nitride, a transparent conductive oxide (TCO), Nb, NbN, NiCrN, MoN, NiₓCR_{y}Nb_{z}, NiₓCR_{y}Nb_{z}N_{α}, GZO or AZO. The first substrate, the reflecting stack and the absorbing stack may be arranged within the window film such that when the window film is installed on an interior surface of a window, light from the sun passes through the substrate before it passes through the reflecting stack and light from the sun passes through the reflecting stack before it passes through the absorbing stack.

According to still another aspect, a method of forming a composite window film may include providing a reflective stack, forming an absorbing stack over the reflective stack and forming a first window facing substrate over the absorbing stack and the reflective stack. The composite window film may have a VLT not greater than about 80%, a TSER of at least about 40%, and an Energetic Absorption (EA) of not greater than about 50%.

### BRIEF DESCRIPTION OF THE DRAWINGS

Embodiments are illustrated by way of example and are not limited in the accompanying figures.

FIG. 1 includes an illustration of an example composite window film according to certain embodiments described herein;

FIGS. 2a-2c include illustrations of other example composite window films according to certain embodiments described herein;

FIGS. 3a-3b include illustrations of other example composite window films according to certain embodiments described herein

FIG. 4 includes an illustration of another example composite window film according to certain embodiments described herein;

FIG. 5 includes an illustration of another example composite window film according to certain embodiments described herein;

FIG. 6 includes an illustration of another example composite window film according to certain embodiments described herein;

FIG. 7 includes a plot of VLT vs. TSER for example composite window films according to certain embodiments described herein;

FIG. 8 includes a plot of VLT vs. TSER for example composite window films according to certain embodiments described herein.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention. Further, the use of the same reference symbols in different drawings indicates similar or identical items.

### DETAILED DESCRIPTION OF THE PREFERRED EMBODIMENTS

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other embodiments can be used based on the teachings as disclosed in this application.

As used herein, the term “visible light transmittance” or “VLT” refers to the ratio of total visible light that is transmitted through a composite stack/transparent substrate system and may be calculated using a D65 light source at a 10° angle.

The term “total solar energy rejected” or “TSER” refers to the total solar energy (heat) composite stack/transparent substrate system and may be calculated according to ISO 9050.

The term “energetic absorption” or “EA” refers to direct solar absorption as defined in ISO9050.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the solar control arts.

Embodiments described herein are generally directed to composite window films that include a multi-layer structure having at least one substrate layer, at least one reflecting stack that includes a functional layer and at least one absorbing stack that includes an absorbing layer. According to particular embodiments, the functional layer in the reflecting stack includes a material selected from any one of silver, gold, aluminum, copper, stainless steel, alloys thereof or combinations thereof. According to still other embodiments, the absorbing layer in the absorbing stack includes a material selected from a metal nitride, a transparent conductive oxide (TCO), Nb, NbN, NiCrN, MoN, NiₓCR_{y}Nb_{z}, NiₓCR_{y}Nb_{z}N_{α}, GZO or AZO. The composite window films formed according to embodiments described herein may have particular performance characteristics, such as, high visible light transmittance, high TSER, low energetic absorption or a combination thereof.

These concepts are better understood in view of the embodiments described below that illustrate and do not limit the scope of the present disclosure.

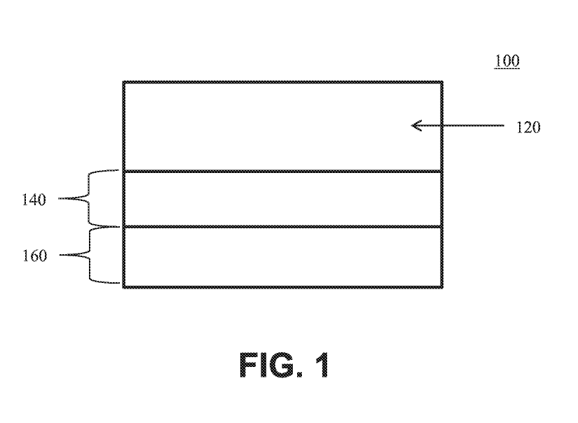

FIG. 1 includes an illustration of a cross-sectional view of a portion of an example composite window film 100 formed according to embodiments described herein. As shown in FIG. 1, the composite window film 100 may include a first substrate layer 120, a reflecting stack 140, and an absorbing stack 160. According to particular embodiments, the first substrate layer 120 may be defined as the window facing substrate, which is the substrate in the composite window film that would be closest to a window when the composite window film 100 is installed on a window.

As shown in FIG. 1, the reflecting stack 140 may be located between the first substrate 120 and the absorbing stack 160. According to another embodiment and as also shown in FIG. 1, the first substrate 120, the reflecting stack 140 and the absorbing stack 160 may be arranged within the window film 100 such that when the window film 100 is installed on an interior surface of a window (not shown in FIG. 1) light from the sun passes through the first substrate 120 before it passes through the reflecting stack 140 and light from the sun passes through the reflecting stack 140 before it passes through the absorbing stack 160.

According to a particular embodiment, first substrate 120 may include a PET material. According to still other embodiments, the first substrate 120 may consist essentially of a PET material. According to yet other embodiments, the first substrate 120 may be a PET substrate. According to still other embodiments, the PET substrate may include UV blocker additives. According to a particular embodiment, first substrate 120 may include a UV protective PET material. According to still other embodiments, the first substrate 120 may consist essentially of a UV protective PET material. According to yet other embodiments, the first substrate 120 may be a UV protective PET substrate.

According to yet another embodiment, the first substrate 120 may have a particular thickness. For example, the first substrate 120 may have a thickness of at least about 20 microns, such as, at least about 30 microns, at least about 40 microns, at least about 50 microns, at least about 60 microns, at least about 70 microns, at least about 80 microns, at least about 90 microns or even at least about 100 microns. According to still other embodiments, the first substrate 120 may have a thickness of not greater than about 200 microns, such as, not greater than about 190 microns, not greater than about 180 microns, not greater than about 170 microns, not greater than about 160 microns, not greater than about 150 microns, not greater than about 140 microns, not greater than about 130 microns, not greater than about 120 microns or even not greater than about 110 microns. It will be appreciated that the first substrate 120 may have a thickness within a range between any of the minimum and maximum values noted above. It will be further appreciated that the first substrate 120 may have a thickness of any value between any of the minimum and maximum values noted above.

According to still other embodiments, the first substrate layer 120 may be adhered to the rest of the layers in the composite window film 100 using an adhesive material (not shown). According to still other embodiments, the adhesive material may be any known adhesive materials. According to still other embodiments, the adhesive material may be any acrylic based adhesive. According to yet another embodiment, the adhesive material may be any silicone based adhesive.

According to certain embodiments, the reflecting stack 140 may include a reflective material. For example, the reflecting stack 140 may include a material selected from any one of silver, gold, aluminum, copper, stainless steel, alloys thereof or combinations thereof.

According to still other embodiments, the reflecting stack 140 may have a particular thickness. For example, the reflecting stack 140 may have a thickness of at least about 30 nm, such as, at least about 40 nm, at least about 50 nm, at least about 60, nm, at least about 70 nm, at least about 80 nm, at least about 90 nm, at least about 100 nm, at least about 125 nm, at least about 150 nm, at least about 175 nm, at least about 200 nm, at least about 225 nm or even at least about 250 nm. According to still other embodiments, the reflecting stack 140 may have a thickness of not greater than about 500 nm, such as, not greater than about 490 nm, not greater than about 480 nm, not greater than about 470 nm, not greater than about 460 nm, not greater than about 450 nm, not greater than about 440 nm, not greater than about 430 nm, not greater than about 420 nm, not greater than about 410 nm, not greater than about 400 nm, not greater than about 375 nm, not greater than about 350 nm, not greater than about 325 nm, not greater than about 300 nm or even not greater than about 275 nm. It will be appreciated that the reflecting stack 140 may have a thickness within a range between any of the minimum and maximum values noted above. It will be further appreciated that the reflecting stack 140 may have a thickness of any value between any of the minimum and maximum values noted above.

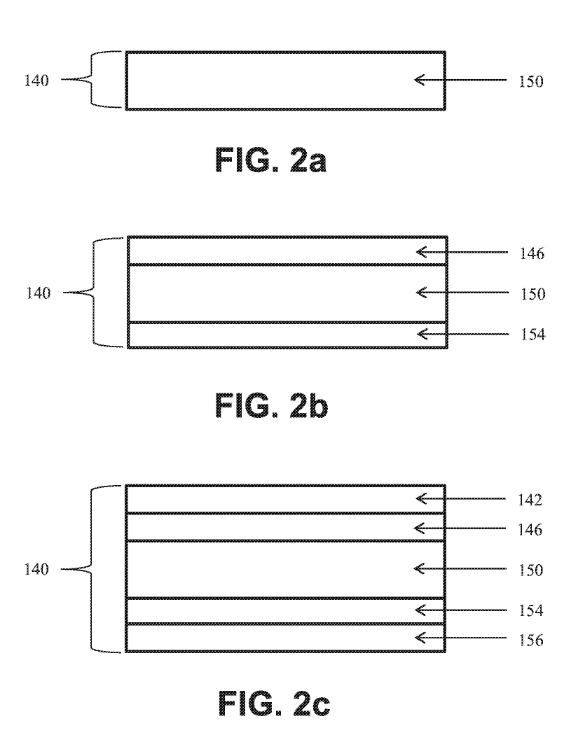

According to particular embodiments, the reflecting stack 140 may include a single layer. According to still other embodiments, the reflecting stack 140 may include multiple layers. FIGS. 2a-2b include illustrations of the cross-sectional view of example reflecting stacks 140.

FIG. 2a includes an illustration of the cross-sectional view of an example reflective stack 140, which includes a single functional layer 150.

It will be appreciated that the reflective stack 140 of FIG. 2a may have any of the characteristics described herein with reference to corresponding stacks or layers in FIG. 1.

According to one embodiment, the functional layer 150 may include a material selected from any one of silver, gold, aluminum, copper, stainless steel, alloys thereof or combinations thereof. According to still other embodiments, the functional layer 150 may consist essentially of silver. According to yet other embodiments, the functional layer 150 may consist essentially of gold. According to still other embodiments, the functional layer 150 may consist essentially of aluminum. According to still other embodiments, the functional layer 150 may consist essentially of copper. According to still other embodiments, the functional layer 150 may consist essentially of stainless steel. According to still other embodiments, the functional layer 150 may consist essentially of an alloy of silver, gold, aluminum, copper or stainless steel. According to yet other embodiments, the functional layer 150 may consist essentially of a combination of silver, gold, aluminum, copper or stainless steel.

According to still other embodiments, the functional layer 150 may have a particular thickness. For example, the functional layer 150 may have a thickness of at least about 5 nm, such as, at least about 6 nm, at least about 7 nm, at least about 8, nm, at least about 9 nm, at least about 10 nm, at least about 11 nm or even at least about 12 nm. According to still other embodiments, the functional layer 150 may have a thickness of not greater than about 20 nm, such as, not greater than about 19 nm, not greater than about 18 nm, not greater than about 17 nm, not greater than about 16 nm or even not greater than about 15 nm. It will be appreciated that the functional layer 150 may have a thickness within a range between any of the minimum and maximum values noted above. It will be further appreciated that the functional layer 150 may have a thickness of any value between any of the minimum and maximum values noted above.

FIG. 2b includes an illustration of the cross-sectional view of an example reflective stack 140, which includes a first blocker layer 146, a functional layer 150 and a second blocker layer 154. As shown in FIG. 2b, the functional layer 150 may be located between the first blocker layer 146 and the second blocker layer 154.

It will be appreciated that the reflective stack 140 and function layer 150 of FIG. 2b may have any of the characteristics described herein with reference to corresponding stacks or layers in FIG. 1 or FIG. 2a.

According to certain embodiments, the first blocker layer 146 may include a corrosion resistant material. According to yet other embodiments, the first blocker layer 146 may include a material selected from any one of Au, Pt, Pd, Nb, Ti, Ni, Cr, Cu, Al, Mg or NiCr. According to yet other embodiments, the first blocker layer 146 may include an oxide of Au, Pt, Pd, Nb, Ti, Ni, Cr, Cu, Al, Mg or NiCr. According to yet other embodiments, the first blocker layer 146 may include an alloy of Au, Pt, Pd, Nb, Ti, Ni, Cr, Cu, Al, Mg or NiCr. According to yet other embodiments, the first blocker layer 146 may include a combination of Au, Pt, Pd, Nb, Ti, Ni, Cr, Cu, Al, Mg or NiCr.

According to still other embodiments, the first blocker layer 146 may have a particular thickness. For example, the first blocker layer 146 may have a thickness of at least about 0.2 nm, such as, at least about 0.4 nm, at least about 0.6 nm, at least about 0.8, nm, at least about 1 nm, at least about 1.5 nm, at least about 2 nm or even at least about 2.5 nm. According to still other embodiments, the first blocker layer 146 may have a thickness of not greater than about 5 nm, such as, not greater than about 4.8 nm, not greater than about 4.6 nm, not greater than about 4.4 nm, not greater than about 4.2 nm or even not greater than about 4 nm. It will be appreciated that the first blocker layer 146 may have a thickness within a range between any of the minimum and maximum values noted above. It will be further appreciated that the first blocker layer 146 may have a thickness of any value between any of the minimum and maximum values noted above.

According to yet other embodiments, the second blocker layer 154 may include a corrosion resistant material. According to yet other embodiments, the second blocker layer 154 may include a material selected from any one of Au, Pt, Pd, Nb, Ti, Ni, Cr, Cu, Al, Mg or NiCr. According to yet other embodiments, the second blocker layer 226 may include an oxide of Au, Pt, Pd, Nb, Ti, Ni, Cr, Cu, Al, Mg or NiCr. According to yet other embodiments, the second blocker layer 154 may include an alloy of Au, Pt, Pd, Nb, Ti, Ni, Cr, Cu, Al, Mg or NiCr. According to yet other embodiments, the second blocker layer 154 may include a combination of Au, Pt, Pd, Nb, Ti, Ni, Cr, Cu, Al, Mg or NiCr.

According to still other embodiments, the second blocker layer 154 may have a particular thickness. For example, the second blocker layer 154 may have a thickness of at least about 0.2 nm, such as, at least about 0.4 nm, at least about 0.6 nm, at least about 0.8, nm, at least about 1 nm, at least about 1.5 nm, at least about 2 nm or even at least about 2.5 nm. According to still other embodiments, the second blocker layer 154 may have a thickness of not greater than about 5 nm, such as, not greater than about 4.8 nm, not greater than about 4.6 nm, not greater than about 4.4 nm, not greater than about 4.2 nm or even not greater than about 4 nm. It will be appreciated that the second blocker layer 154 may have a thickness within a range between any of the minimum and maximum values noted above. It will be further appreciated that the second blocker layer 154 may have a thickness of any value between any of the minimum and maximum values noted above.

FIG. 2c includes an illustration of the cross-sectional view of an example reflective stack 140, which includes first reflecting stack dielectric layer 142, a first blocker layer 146, a functional layer 150, a second blocker layer 154 and a second reflecting stack dielectric layer 156. As shown in FIG. 2c, the first blocker layer 146, the functional layer 150 and the second blocker layer 154 may all be located between the first reflecting stack dielectric layer 142 and the second reflecting stack dielectric layer 156.

It will be appreciated that the reflective stack 140, the first blocker layer 146, the function layer 150 and the second blocker layer 154 of FIG. 2c may have any of the characteristics described herein with reference to corresponding stacks or layers in FIG. 1, FIG. 2a and FIG. 2b.

According to still other embodiments, the first reflecting stack dielectric layer 142 may include a dielectric material. According to still other embodiments, the first reflecting stack dielectric layer 142 may include a material selected from any one of TiO_{X}, NbO_{X}, Si₃N₄, SiZrN, SnZnOx, SiOx, ZnOx, InOₓ, SnO₂, BiO2, PbO, GZO, AZO, ITO, MgZnO, MgO, MoO3, ZrOx or AlOx. According to yet other embodiments, the first reflecting stack dielectric layer 142 may consist essentially of a material selected from any one of TiO_{X}, NbO_{X}, Si₃N₄, SiZrN, SnZnOx, SiOx, ZnOx, InOₓ, SnO₂, BiO2, PbO, GZO, AZO, ITO, MgZnO, MgO, MoO3, ZrOx or AlOx.

According to still other embodiments, the first reflecting stack dielectric layer 142 may have a particular thickness. For example, the first reflecting stack dielectric layer 142 may have a thickness of at least about 10 nm, such as, at least about 20 nm, at least about 30 nm, at least about 40, nm, at least about 50 nm, at least about 75 nm, at least about 100 nm or even at least about 150 nm. According to still other embodiments, the first reflecting stack dielectric layer 142 may have a thickness of not greater than about 250 nm, such as, not greater than about 240 nm, not greater than about 230 nm, not greater than about 220 nm, not greater than about 210 nm or even not greater than about 200 nm. It will be appreciated that the first reflecting stack dielectric layer 142 may have a thickness within a range between any of the minimum and maximum values noted above. It will be further appreciated that the first reflecting stack dielectric layer 142 may have a thickness of any value between any of the minimum and maximum values noted above.

According to still other embodiments, the second reflecting stack dielectric layer 156 may include a dielectric material. According to still other embodiments, the second reflecting stack dielectric layer 156 may include a material selected from any one of TiO_{X}, NbO_{X}, Si₃N₄, SiZrN, SnZnOx, SiOx, ZnOx, InOₓ, SnO₂, BiO2, PbO, GZO, AZO, ITO, MgZnO, MgO, MoO3, ZrOx or AlOx. According to yet other embodiments, the second reflecting stack dielectric layer 156 may consist essentially of a material selected from any one of TiO_{X}, NbO_{X}, Si₃N₄, SiZrN, SnZnOx, SiOx, ZnOx, InOₓ, SnO₂, BiO2, PbO, GZO, AZO, ITO, MgZnO, MgO, MoO3, ZrOx or AlOx.

According to still other embodiments, the second reflecting stack dielectric layer 156 may have a particular thickness. For example, the second reflecting stack dielectric layer 156 may have a thickness of at least about 10 nm, such as, at least about 20 nm, at least about 30 nm, at least about 40, nm, at least about 50 nm, at least about 75 nm, at least about 100 nm or even at least about 150 nm. According to still other embodiments, second reflecting stack dielectric layer 156 may have a thickness of not greater than about 250 nm, such as, not greater than about 240 nm, not greater than about 230 nm, not greater than about 220 nm, not greater than about 210 nm or even not greater than about 200 nm. It will be appreciated that the second reflecting stack dielectric layer 156 may have a thickness within a range between any of the minimum and maximum values noted above. It will be further appreciated that the second reflecting stack dielectric layer 156 may have a thickness of any value between any of the minimum and maximum values noted above.

Referring back to FIG. 1, the absorbing stack 160 may include an absorbing material. For example, the absorbing stack 160 may include a material selected from any one of a metal nitride or a transparent conductive oxide (TCO). According to yet particular embodiments, the absorbing stack 160 may include a material selected from any one of Nb, NbN, NiCrN, MoN, NiₓCR_{y}Nb_{z}, NiₓCR_{y}Nb_{z}N_{α}, GZO or AZO.

According to still other embodiments, the absorbing stack 160 may have a particular thickness. For example, the absorbing stack 160 may have a thickness of at least about 5 nm, such as, at least about 10, at least about 20 nm, at least about 30 nm, at least about 40 nm, at least about 50 nm, at least about 60, nm, at least about 70 nm, at least about 80 nm, at least about 90 nm, at least about 100 nm, at least about 125 nm, at least about 150 nm, at least about 175 nm, at least about 200 nm, at least about 225 nm or even at least about 250 nm. According to still other embodiments, the absorbing stack 160 may have a thickness of not greater than about 700 nm, such as, not greater than about 690 nm, not greater than about 680 nm, not greater than about 670 nm, not greater than about 660 nm, not greater than about 650 nm, not greater than about 640 nm, not greater than about 630 nm, not greater than about 620 nm, not greater than about 610 nm, not greater than about 600 nm, not greater than about 575 nm, not greater than about 550 nm, not greater than about 525 nm, not greater than about 500 nm or even not greater than about 475 nm. It will be appreciated that the absorbing stack 160 may have a thickness within a range between any of the minimum and maximum values noted above. It will be further appreciated that the absorbing stack 160 may have a thickness of any value between any of the minimum and maximum values noted above.

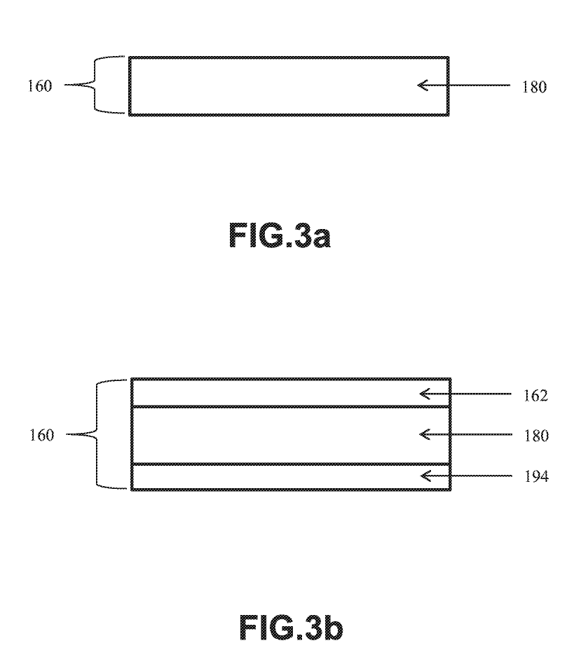

According to particular embodiments, the absorbing stack 160 may include a single layer. According to still other embodiments, the absorbing stack 160 may include multiple layers. FIGS. 3a-3b include illustrations of the cross-sectional view of example absorbing stack 160.

FIG. 3a includes an illustration of the cross-sectional view of an example absorbing stack 160, which includes a single absorbing layer 180.

It will be appreciated that the absorbing stack 160 of FIG. 3a may have any of the characteristics described herein with reference to corresponding stacks or layers in FIG. 1.

According to one embodiment, the absorbing layer 180 may include a material selected from any one of a metal nitride or a transparent conductive oxide (TCO). According to yet particular embodiments, the absorbing layer 180 may include a material selected from any one of Nb, NbN, NiCrN, MoN, NiₓCR_{y}Nb_{z}, NiₓCR_{y}Nb_{z}N_{α}, GZO or AZO. According to yet other embodiments, the absorbing layer 180 may consist essentially of a metal nitride. According to yet other embodiments, the absorbing layer 180 may consist essentially of a transparent conductive oxide (TCO). According to still other embodiments, the absorbing layer 180 may consist essentially of NbN. According to still other embodiments, the absorbing layer 180 may consist essentially of NiCrN. According to still other embodiments, the absorbing layer 180 may consist essentially of MoN. According to still other embodiments, the absorbing layer 180 may consist essentially of GZO. According to still other embodiments, the absorbing layer 180 may consist essentially of AZO.

According to still other embodiments, the absorbing layer 180 may have a particular thickness. For example, the absorbing layer 180 may have a thickness of at least about 1 nm, such as, at least about 2 nm, at least about 3 nm, at least about 4 nm, at least about 5 nm, at least about 10 nm, at least about 20 nm, at least about 30, nm, at least about 40 nm, at least about 50 nm, at least about 75 nm or even at least about 100 nm. According to still other embodiments, the absorbing layer 180 may have a thickness of not greater than about 500 nm, such as, not greater than about 450 nm, not greater than about 400 nm, not greater than about 350 nm, not greater than about 300 nm or even not greater than about 250 nm. It will be appreciated that the absorbing layer 180 may have a thickness within a range between any of the minimum and maximum values noted above. It will be further appreciated that the absorbing layer 180 may have a thickness of any value between any of the minimum and maximum values noted above.

FIG. 3b includes an illustration of the cross-sectional view of an example absorbing layer 180, which includes a first absorbing stack dielectric layer 162, an absorbing layer 180 and a second absorbing stack dielectric layer 194. As shown in FIG. 3b, the absorbing layer 180 may be located between the first absorbing stack dielectric layer 162 and the second absorbing stack dielectric layer 194.

It will be appreciated that the absorbing stack 160 and absorbing layer 180 of FIG. 3b may have any of the characteristics described herein with reference to corresponding stacks or layers in FIG. 1 or 3a.

According to still other embodiments, the first absorbing stack dielectric layer 162 may include a dielectric material. According to still other embodiments, the absorbing stack dielectric layer 162 may include a material selected from any one of TiO_{X}, NbO_{X}, Si₃N₄, SiZrN, SnZnOx, SiOx, ZnOx, InOₓ, SnO₂, BiO2, PbO, GZO, AZO, ITO, MgZnO, MgO, MoO3, ZrOx or AlOx. According to yet other embodiments, the first absorbing stack dielectric layer 162 may consist essentially of a material selected from any one of TiO_{X}, NbO_{X}, Si₃N₄, SiZrN, SnZnOx, SiOx, ZnOx, InOₓ, SnO₂, BiO2, PbO, GZO, AZO, ITO, MgZnO, MgO, MoO3, ZrOx or AlOx.

According to still other embodiments, the first absorbing stack dielectric layer 162 may have a particular thickness. For example, the first absorbing stack dielectric layer 162 may have a thickness of at least about 10 nm, such as, at least about 20 nm, at least about 30 nm, at least about 40, nm, at least about 50 nm, at least about 75 nm, at least about 100 nm or even at least about 150 nm. According to still other embodiments, the first absorbing stack dielectric layer 162 may have a thickness of not greater than about 250 nm, such as, not greater than about 240 nm, not greater than about 230 nm, not greater than about 220 nm, not greater than about 210 nm or even not greater than about 200 nm. It will be appreciated that the first absorbing stack dielectric layer 162 may have a thickness within a range between any of the minimum and maximum values noted above. It will be further appreciated that the first absorbing stack dielectric layer 162 may have a thickness of any value between any of the minimum and maximum values noted above.

According to still other embodiments, the second absorbing stack dielectric layer 194 may include a dielectric material. According to still other embodiments, the absorbing stack dielectric layer 194 may include a material selected from any one of TiO_{X}, NbO_{X}, Si₃N₄, SiZrN, SnZnOx, SiOx, ZnOx, InOₓ, SnO₂, BiO2, PbO, GZO, AZO, ITO, MgZnO, MgO, MoO3, ZrOx or AlOx. According to yet other embodiments, the second absorbing stack dielectric layer 194 may consist essentially of a material selected from any one of TiO_{X}, NbO_{X}, Si₃N₄, SiZrN, SnZnOx, SiOx, ZnOx, InOₓ, SnO₂, BiO2, PbO, GZO, AZO, ITO, MgZnO, MgO, MoO3, ZrOx or AlOx.

According to still other embodiments, the absorbing stack dielectric layer 194 may have a particular thickness. For example, the absorbing stack dielectric layer 194 may have a thickness of at least about 10 nm, such as, at least about 20 nm, at least about 30 nm, at least about 40, nm, at least about 50 nm, at least about 75 nm, at least about 100 nm or even at least about 150 nm. According to still other embodiments, the absorbing stack dielectric layer 194 may have a thickness of not greater than about 250 nm, such as, not greater than about 240 nm, not greater than about 230 nm, not greater than about 220 nm, not greater than about 210 nm or even not greater than about 200 nm. It will be appreciated that the absorbing stack dielectric layer 194 may have a thickness within a range between any of the minimum and maximum values noted above. It will be further appreciated that the absorbing stack dielectric layer 194 may have a thickness of any value between any of the minimum and maximum values noted above.

Again referring back to FIG. 1 and according to still other embodiments, the composite window film 100 may have a particular thickness. For example, the composite window film 100 may have a thickness of at least about 25 nm, such as, at least about 50 nm, at least about 75 nm, at least about 100 nm, at least about 125 nm, at least about 150 nm, at least about 175 nm, at least about 200 nm, at least about 250 nm, at least about 300 nm, at least about 350 nm, at least about 400 nm, at least about 450 nm or even at least about 500 nm. According to still other embodiments, the composite window film 100 may have a thickness of not greater than about 1000 nm, such as, not greater than about 950 nm, not greater than about 900 nm, not greater than about 850 nm, not greater than about 800 nm, not greater than about 750 nm, not greater than about 700 nm, not greater than about 650 nm or even not greater than about 600 nm. It will be appreciated that the composite window film 100 may have a thickness within a range between any of the minimum and maximum values noted above. It will be further appreciated that the composite window film 100 may have a thickness of any value between any of the minimum and maximum values noted above.

According to still other embodiments, the composite window film 100 may have a particular VLT. For example, the composite window film 100 may have a VLT of at least about, such as, at least about 5%, at least about 10%, at least about 20%, at least about 30%, at least about 40%, at least about 50%, at least about 60%, at least about 70%, at least about 75% or even at least about 80%. According to still another embodiment, the composite window film 100 may have a VLT of not greater than about 85%. It will be appreciated that the composite window film 100 may have a VLT within a range between any of the minimum and maximum values noted above. It will be further appreciated that the composite window film 100 may have a VLT of any value between any of the minimum and maximum values noted above.

According to yet other embodiments, the composite window film 100 may have a particular TSER. For example, the composite window film 100 may have a TSER of at least about at least about 25%, such as, at least about 30%, at least about 40%, at least about 50%, at least about 60%, at least about 70% or even at least about 75%. According to yet another embodiment, the composite window film 100 may have a TSER of not greater than about 80%. It will be appreciated that the composite window film 100 may have a TSER within a range between any of the minimum and maximum values noted above. It will be further appreciated that the composite window film 100 may have a TSER of any value between any of the minimum and maximum values noted above.

According to yet other embodiments, the composite window film 100 may have a particular EA. For example, the composite window film 100 may have an EA of at least about at least about 20%, such as, at least about 30%, at least about 40% or even at least about 50%. According to still other embodiments, the composite window film 100 may have an EA of not greater than about 60%, such as, not greater than about 57%, not greater than about 55% or even not greater than about 52%. It will be appreciated that the composite window film 100 may have an EA within a range between any of the values noted above. It will be further appreciated that the composite window film 100 may have an EA of any value between any of the values noted above.

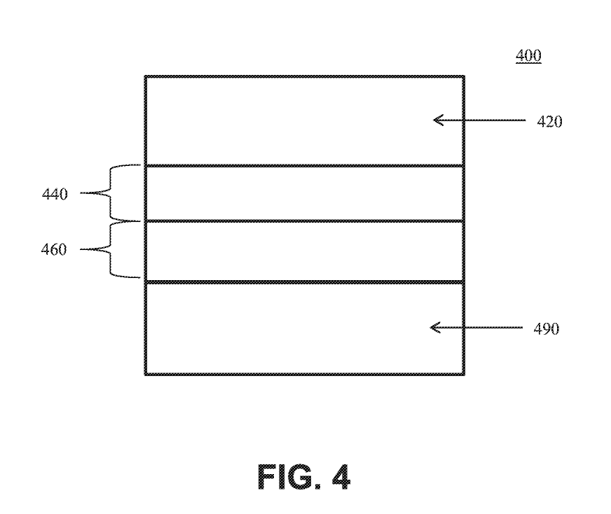

FIG. 4 includes an illustration of a cross-sectional view of a portion of an example composite window film 400 formed according to another embodiment described herein. As shown in FIG. 4, the composite window film 400 may include a first substrate layer 420, a reflecting stack 440, an absorbing stack 460 and a second substrate layer 490.

It will be appreciated that the composite window film 400, the first substrate 420, the reflecting stack 440 and the absorbing stack 460 of FIG. 1 may have any of the characteristics described herein with reference to corresponding stacks or layers in FIG. 1.

As show in FIG. 4, the reflecting stack 440 and the absorbing stack 460 may be located between the first substrate 420 and the second substrate 490. According to another embodiment and as also shown in FIG. 4, the first substrate 420, the reflecting stack 440, the absorbing stack 460 and the second substrate 490 may be arranged within the window film 400 such that when the window film 400 is installed on an interior surface of a window (not shown in FIG. 4) light from the sun passes through the first substrate 420 before it passes through the reflecting stack 440, light from the sun passes through the reflecting stack 440 before it passes through the absorbing stack 460 and light from the sun passes through the absorbing stack 460 before it passes through the second substrate 490.

According to a particular embodiment, the second substrate 490 may include a PET material. According to still other embodiments, the second substrate 490 may consist essentially of a PET material. According to yet other embodiments, the second substrate 490 may be a PET substrate. According to yet another embodiment, the second substrate 490 may have a particular thickness. For example, the second substrate 490 may have a thickness of at least about 20 microns, such as, at least about 30 microns, at least about 40 microns, at least about 50 microns, at least about 60 microns, at least about 70 microns, at least about 80 microns, at least about 90 microns or even at least about 100 microns. According to still other embodiments, the second substrate 490 may have a thickness of not greater than about 200 microns, such as, not greater than about 190 microns, not greater than about 180 microns, not greater than about 170 microns, not greater than about 160 microns, not greater than about 150 microns, not greater than about 140 microns, not greater than about 130 microns, not greater than about 120 microns or even not greater than about 110 microns. It will be appreciated that the second substrate 490 may have a thickness within a range between any of the minimum and maximum values noted above. It will be further appreciated that the second substrate 490 may have a thickness of any value between any of the minimum and maximum values noted above.

According to still other embodiments, the second substrate 490 may be adhered to the rest of the layers in the composite window film 400 using an adhesive material (not shown). According to still other embodiments, the adhesive material may be any known adhesive materials. According to still other embodiments, the adhesive material may be any acrylic based adhesive. According to yet another embodiment, the adhesive material may be any silicone based adhesive.

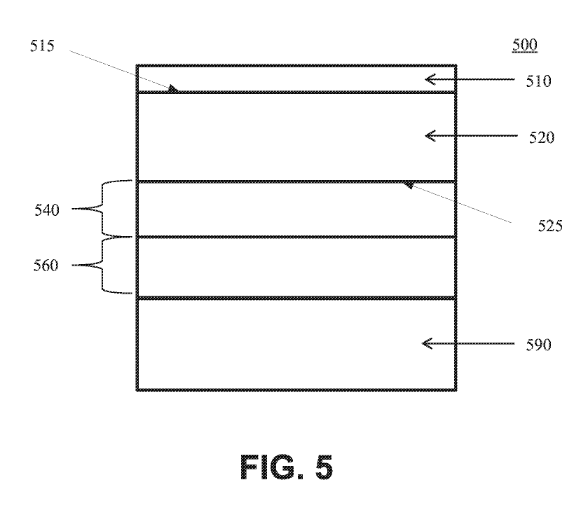

FIG. 5 includes an illustration of a cross-sectional view of a portion of an example composite window film 500 formed according to another embodiment described herein. As shown in FIG. 5, the composite window film 500 may include a pressure sensitive adhesive 510, a first substrate layer 520, a reflecting stack 540, an absorbing stack 560 and a second substrate layer 590.

It will be appreciated that the window film 500, the first substrate layer 520, the reflecting stack 540, the absorbing stack 560 and the second substrate layer 590 of FIG. 5 may have any of the characteristics described herein with reference to corresponding stacks or layers in FIGS. 1, 2a-2c, 3a-3b or 4.

As show in FIG. 5, the pressure sensitive adhesive 510 may disposed on a first surface 515 of the first substrate layer 520. The first surface 515 of the first substrate layer 520 may be opposite of and spaced away from a second surface 525 of the first substrate. According to particular embodiments, the first surface 515 of the first substrate layer 520 may be defined as the window facing surface of the substrate, which is the surface of the substrate that would be closest to a window when the composite window film 500 is installed on a window.

According to particular embodiments, all layers of the composite stack formed on or between the first and second substrates as described herein may be formed using any suitable technique. For example, all layers of the composite stack formed on or between the first and second substrates as described herein may be formed using magnetron sputtering. According to still other embodiments, all layers of the composite stack formed on or between the first and second substrates as described herein may be formed using physical vapor deposition.

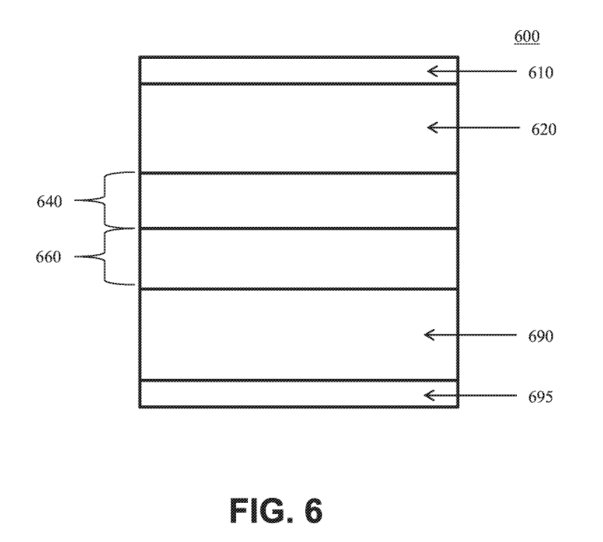

FIG. 6 includes an illustration of a cross-sectional view of a portion of an example composite window film 600 formed according to another embodiment described herein. As shown in FIG. 6, the composite window film 600 may include a pressure sensitive adhesive 610, a first substrate layer 620, a reflecting stack 640, an absorbing stack 660, a second substrate layer 690 and a hard coat layer 695.

It will be appreciated that the window film 600, the pressure sensitive adhesive 610, the first substrate layer 620, the reflecting stack 640, the absorbing stack 660 and the second substrate layer 690 of FIG. 6 may have any of the characteristics described herein with reference to corresponding stacks or layers in FIGS. 1, 2a-2c, 3a-3b, 4 or 5.

As shown in FIG. 6, the hard coat layer 695 may disposed on the second substrate 690 and may be the outer most layer of the composite window film 600. According to particular embodiments, the outer most layer of the composite window film 600 may be defined as the layer farthest away from a window when the composite window film 500 is installed on a window.

According to particular embodiments, all layers of the composite stack formed on or between the first and second substrates as described herein may be formed using any suitable technique. For example, all layers of the composite stack formed on or between the first and second substrates as described herein may be formed using magnetron sputtering. According to still other embodiments, all layers of the composite stack formed on or between the first and second substrates as described herein may be formed using physical vapor deposition.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

### Embodiment 1

A composite window film comprising: a first window facing substrate; a reflecting stack; and an absorbing stack, wherein the reflecting stack is located between the first window facing substrate and the absorbing stack, wherein the composite window film has a VLT of not greater than about 80%, wherein the composite window film has a TSER of at least about 40%, and wherein the composite window film has an Energetic Absorption (EA) of not greater than about 50%.

### Embodiment 2

A composite window film comprising: a first substrate having a first surface and a second surface opposite of and spaced away from the first surface; a pressure sensitive adhesive layer disposed on the first surface of the first substrate; a reflecting stack comprising a functional layer, wherein the functional layer comprises silver, gold, aluminum, copper, stainless steel, alloys thereof or combinations thereof; and an absorbing stack comprising an absorber layer, wherein the absorber layer comprises a metal nitride, a transparent conductive oxide (TCO), NbN, NiCrN, MoN, GZO or AZO, wherein the first substrate is located between the pressure sensitive adhesive layer and the reflecting stack, and wherein the reflecting stack is located between the first substrate and the absorbing stack.

### Embodiment 3

A composite window film comprising: a first substrate; a reflecting stack comprising a functional layer, wherein the functional layer comprises silver, gold, aluminum, copper, stainless steel, alloys thereof or combinations thereof; and an absorbing stack comprising an absorber layer, wherein the absorber layer comprises a metal nitride, a transparent conductive oxide (TCO), NbN, NiCrN, MoN, GZO or AZO, wherein the first substrate, the reflecting stack and the absorbing stack are arranged within the window film such that when the window film is installed on an interior surface of a window, light from the sun passes through the substrate before it passes through the reflecting stack and light from the sun passes through the reflecting stack before it passes through the absorbing stack.

### Embodiment 4

A method of forming a window film, wherein the method comprises: providing an absorbing stack; forming a reflecting stack over the absorbing stack; and forming a first window facing substrate over the reflecting stack, wherein the composite window film has a VLT of not greater than about 80%, wherein the composite window film has a TSER of at least about 40%, and wherein the composite window film has an Energetic Absorption (EA) of not greater than about 50%.

### Embodiment 5

The composite window film or method of embodiments 1 and 4, wherein the functional layer comprises silver, gold, aluminum, copper, stainless steel, alloys thereof or combinations thereof.

### Embodiment 6

The composite window film or method of any one of embodiments 1, 2, 3 and 4, wherein the functional layer consists of silver, gold, aluminum, copper, stainless steel, alloys thereof or combinations thereof.

### Embodiment 7

The composite window film or method of any one of embodiments 1 and 4, wherein the absorbing stack comprises a metal nitride, a transparent conductive oxide (TCO), Nb, NbN, NiCrN, MoN, NiₓCR_{y}Nb_{z}, NiₓCR_{y}Nb_{z}N_{α}, GZO or AZO.

### Embodiment 8

The composite window film or method of any one of embodiments 1, 2, 3 and 4, wherein the absorbing stack consists of a metal nitride, a transparent conductive oxide (TCO), Nb, NbN, NiCrN, MoN, NiₓCR_{y}Nb_{z}, NiₓCR_{y}Nb_{z}N_{α}, GZO or AZO.

### Embodiment 9

The composite window film or method of any one of embodiments 1, 2, 3 and 4, wherein the absorbing stack comprises a first absorbing stack dielectric layer and a second absorbing stack dielectric layer.

### Embodiment 10

The composite window film or method of embodiment 9, wherein the absorber layer is located between the first absorbing stack dielectric layer and the second absorbing stack dielectric layer.

### Embodiment 11

The composite window film or method of any one of embodiments 9 and 10, wherein the first absorbing stack dielectric layer and the second absorbing stack dielectric layers each comprise TiOX, NbOX, Si₃N₄, SiZrN, SnZnOₓ, SiOₓ, ZnOₓ, InOₓ, SnO₂, BiO₂, PbO, GZO, AZO, ITO, MgZnO, MgO, MoO₃, ZrOₓ or AlOₓ.

### Embodiment 12

The composite window film or method of any one of embodiments 1, 2, 3 and 4, wherein the reflecting stack further comprises a first blocker layer and a second blocker layer.

### Embodiment 13

The composite window film or method of embodiment 12, wherein the functional layer is located between the first blocker layer and the second blocker layer.

### Embodiment 14

The composite window film or method of embodiment 12, wherein the functional layer is located between the first blocker layer and the second blocker layer.

### Embodiment 15

The composite window film or method of any one of embodiments 12, 13 and 14, wherein the first blocker layer and the second blocker layer each comprise Ti, Cu, Ni, Cr, Pt, Au, Pd, Nb, NiCr, oxides thereof, alloys thereof or combinations thereof.

### Embodiment 16

The composite window film or method of any one of embodiments 12, 13 and 14, wherein the first blocker layer and the second blocker layer each consist of Ti, Cu, Ni, Cr, Pt, Au, Pd, Nb, NiCr, oxides thereof, alloys thereof or combinations thereof.

### Embodiment 17

The composite window film or method of any one of embodiments 1, 2, 3 and 4, wherein the reflecting stack comprises a first reflecting stack dielectric layer and a second reflecting stack dielectric layer.

### Embodiment 18

The composite window film or method of embodiment 9, wherein the functional layer, first blocker layer and second blocker layer are all located between the first reflecting stack dielectric layer and the second reflecting stack dielectric layer.

### Embodiment 19

The composite window film or method of any one of embodiments 17 and 18, wherein the first reflecting stack dielectric layer and the second reflecting stack dielectric layers each comprise TiO_{X}, NbO_{X}, Si₃N₄, SiZrN, SnZnOₓ, SiOₓ, ZnOₓ, InOₓ, SnO₂, BiO₂, PbO, GZO, AZO, ITO, MgZnO, MgO, MoO₃, ZrOₓ or AlOₓ.

### Embodiment 20

The composite window film or method of any one of embodiments 1, 2, 3 and 4, wherein the first substrate comprises PET.

### Embodiment 21

The composite window film or method of any one of embodiments 1, 2, 3 and 4, wherein the first substrate comprises a UV protective PET.

### Embodiment 22

The composite window film or method of any one of embodiments 1, 2, 3 and 4, wherein the UV protective PET layer comprises UV blocker additives.

### Embodiment 23

The composite window film or method of any one of embodiments 1, 3 and 4, wherein the window film further comprises a pressure sensitive adhesive disposed on a first surface of the first substrate, wherein the first surface is opposite of and spaced away from a second surface of the first substrate, wherein the first surface is a window facing surface.

### Embodiment 24

The composite window film or method of any one of embodiments 1, 2, 3 and 4, the window film further comprises a second substrate.

### Embodiment 25

The composite window film or method of embodiment 24, wherein the reflecting stack and the absorbing stack are both located between the first substrate and the second substrate.

### Embodiment 26

The composite window film or method of any one of embodiments 24 and 25, wherein the second substrate comprises PET.

### Embodiment 27

The composite window film or method of any one of embodiments 1, 2, 3 and 4, wherein the window film further comprises a hardcoat layer, wherein the hardcoat layer is the furthest layer from the first substrate.

### Embodiment 28

The composite window film or method of embodiment 27, wherein the hardcoat layer comprises an acrylic material.

### Embodiment 29

The composite window film or method of embodiment 23, wherein the pressure sensitive adhesive comprises an adhesive material.

### Embodiment 30

The composite window film or method of embodiment 23, wherein the pressure sensitive adhesive consists of an adhesive material.

### Embodiment 31

The composite window film or method of any one of embodiments 1, 2, 3 and 4, wherein the window film has a VLT of at least about 1%.

### Embodiment 32

The composite window film or method of any one of embodiments 1, 2, 3 and 4, wherein the window film has a VLT of not greater than about 85%.

### Embodiment 33

The composite window film or method of any one of embodiments 1, 2, 3 and 4, wherein the window film has a TSER of at least about 25%.

### Embodiment 34

The composite window film or method of any one of embodiments 1, 2, 3 and 4, wherein the window film has a TSER of not greater than about 80%.

### Embodiment 35

The composite window film or method of any one of embodiments 1, 2, 3 and 4, wherein the window film has an Energetic Absorption (EA) of not greater than about 50%.

### Embodiment 36

The composite window film or method of any one of embodiments 1, 2, 3 and 4, wherein the window film has a thickness of at least about 25 nm.

### Embodiment 37

The composite window film or method of any one of embodiments 1, 2, 3 and 4, wherein the window film has a thickness of not greater than about 1000 nm.

### Embodiment 38

The composite window film or method of any one of embodiments 1, 2, 3 and 4, wherein the absorbing stack has a thickness of at least about 10 nm.

### Embodiment 39

The composite window film or method of any one of embodiments 1, 2, 3 and 4, wherein the absorbing stack has a thickness of not greater than about 700 nm.

### Embodiment 40

The composite window film or method of any one of embodiments 1, 2, 3 and 4, wherein the absorbing layer has a thickness of at least about 1 nm.

### Embodiment 41

The composite window film or method of any one of embodiments 1, 2, 3 and 4, wherein the absorbing layer has a thickness of not greater than about 500 nm.

### Embodiment 42

The composite window film or method of any one of embodiments 1, 2, 3 and 4, wherein the reflecting stack has a thickness of at least about 30 nm.

### Embodiment 43

The composite window film or method of any one of embodiments 1, 2, 3 and 4, wherein the reflecting stack has a thickness of not greater than about 500 nm.

### Embodiment 44

The composite window film or method of any one of embodiments 1, 2, 3 and 4, wherein each functional layer has a thickness of at least about 5 nm.

### Embodiment 45

The composite window film or method of any one of embodiments 1, 2, 3 and 4, wherein each functional layer has a thickness of not greater than about 20 nm.

### Embodiment 46

The composite window film or method of any one of embodiments 13, 14, 15 and 16, wherein each of the blocker layers has a thickness of at least about 0.2 nm.

### Embodiment 47

The composite window film or method of any one of embodiments 13, 14, 15 and 16, wherein each of the blocker layers has a thickness of not greater than about 5 nm.

### Embodiment 48

The composite window film or method of any one of embodiments 9, 10 and 11, wherein each of the absorbing stack dielectric layers has a thickness of at least about 10 nm.

### Embodiment 49

The composite window film or method of any one of embodiments 9, 10 and 11, wherein each of the absorbing stack dielectric layers has a thickness of not greater than about 250 nm.

### Embodiment 50

The composite window film or method of any one of embodiments 17, 18 and 19, wherein each of the reflecting stack dielectric layers has a thickness of at least about 10 nm.

### Embodiment 51

The composite window film or method of any one of embodiments 17, 18 and 19, wherein each of the reflecting stack dielectric layers has a thickness of not greater than about 250 nm.

### Embodiment 52

The composite window film or method of any one of embodiments 1, 2, 3 and 4, wherein the first substrate has a thickness of at least about 20 microns.

### Embodiment 53

The composite window film or method of any one of embodiments 1, 2, 3 and 4, wherein the first substrate has a thickness of not greater than about 200 microns.

### Embodiment 54

The composite window film or method of any one of embodiments 1, 2, 3 and 4, wherein the second substrate has a thickness of at least about 20 microns.

### Embodiment 55

The composite window film or method of any one of embodiments 1, 2, 3 and 4, wherein the second substrate has a thickness of not greater than about 200 microns.

### EXAMPLES

The concepts described herein will be further described in the following Examples, which do not limit the scope of the invention described in the claims. Some of the parameters below have been approximated for convenience.

In the Examples below, the sample composite window films are prepared by magnetron sputtering deposition under vacuum conditions and are deposited on PET substrates. PSA and adhesives are deposited by wet-coating. The lamination process allows assembly of coated PET with PSA and counter-PET.

### Example 1

Three sample composite window films (S1-S3) were configured and formed according to certain embodiments described herein.

Sample Si was formed with a layer configuration of Window/PET-1/RS1/AS1/PET-2. PET-1 is a first substrate layer formed from a PET material. RS1 is a reflective stack with a layer configuration of TiO/Au/Ag/Au/TiO. AS1 is an absorbing stack with a single NbN layer. PET-2 is a second substrate layer formed from a PET material.

Sample S2 was formed with a layer configuration of Window/PET-1/RS1/AS2/PET-2. PET-1 is a first substrate layer formed from a PET material. RS1 is a reflective stack with a layer configuration of TiO/Au/Ag/Au/TiO. AS2 is an absorbing stack with a layer configuration of TiO/NbN/TiO. PET-2 is a second substrate layer formed from a PET material.

Sample S3 was formed with a layer configuration of Window/PET-1/RS1/AS3/PET-2. PET-1 is a first substrate layer formed from a PET material. RS1 is a reflective stack with a layer configuration of TiO/Au/Ag/Au/TiO. AS3 is an absorbing stack with a layer configuration of NbN/TiO. PET-2 is a second substrate layer formed from a PET material. A comparative sample composite window film (CS1) was formed for performance comparison to sample composite window films S1-S3.

Comparative sample CS1 was formed with a layer configuration of Window/PET-1/AS1/RS1/PET-2. PET-1 is a first substrate layer formed from a PET material. AS1 is an absorbing stack with a single NbN layer. RS1 is a reflective stack with a layer configuration of TiO/Au/Ag/Au/TiO. PET-2 is a second substrate layer formed from a PET material.

Performance of each sample composite window film S1-S3 and comparative composite window film CS1 were modeled and compared.

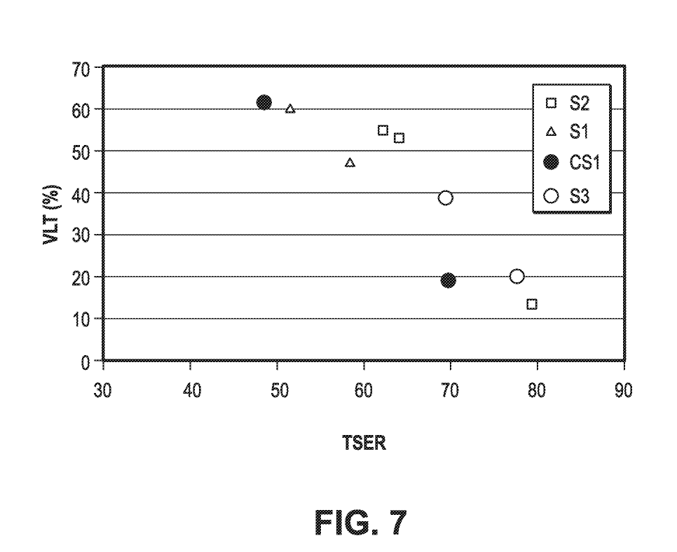

FIG. 7 is a plot of VLT vs. TSER for each of sample composite window film S1-S3 and comparative composite window film CS1. As shown in FIG. 7, when compared to comparative composite window film CS1, sample composite window films S1-S3 allow a high selectivity (i.e., the ratio VLT/(100-TSER)) compared to comparative options.

### Example 2

Seven sample composite window films (S4-S10) were configured and formed according to certain embodiments described herein.

All seven sample composite window films S4-S8 were formed with a layer configuration of Window/PET-1/RS1/AS2/PET-2. PET-1 is a first substrate layer formed from a PET material. RS1 is a reflective stack with a layer configuration of TiO/Au/Ag/Au/TiO. AS2 is an absorbing stack with a layer configuration of TiO/NbN/TiO. PET-2 is a second substrate layer formed from a PET material.

Each of sample composite window films S4-S7, the absorbing stack AS2 had a different NbN layer configuration. In sample S4, the NbN layer configuration was light/QV-NbN40. In sample S5, the NbN layer configuration was light/NbN20-QV. In sample S6, the NbN layer configuration was light/NbN40-QV. In sample S7, the NbN layer configuration was light/QV-NbN20. For examples S4-S7, the QV stack has a thin layer configuration of TiOx/Au/Ag/Au/TiOx.

Two comparative samples composite window films CS2 and CS3 were formed for performance comparison to sample composite window films S1-S7. CS2 is a commercial window film having only a reflective stack. CS3 is a comparative sample window film with two absorber stacks.

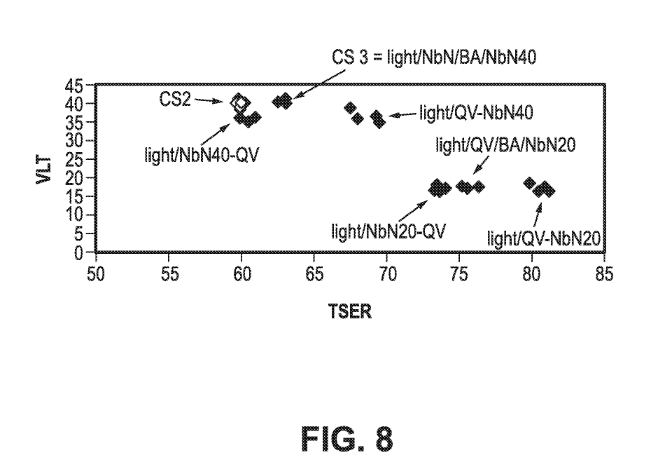

Performances of each sample composite window film S4-S10 were measured. FIG. 8 is a plot of VLT vs. TSER for each of sample composite window films S4-S8 and comparative window films CS2 and CS3. FIG. 8 shows that, in window film samples having a VLT <50%, the proposed stack orientation (i.e., an absorption stack followed by a reflective stack) allows higher selectivity than comparative films combining two absorbing stacks.

The foregoing embodiments represent a departure from the state-of-the-art. Notably, the composite window film embodiments described herein include a combination of features not previously recognized in the art and facilitate performance improvements. Such features can include, but are not limited to, particular configurations of layers within the composite window film, including the arrangement of the reflecting stack and the absorbing stack so that when the window film is in use, light passes through the reflecting stack before light passes through the absorbing stack. The composite stack embodiments described herein have demonstrated remarkable and unexpected improvements over state-of-the-art composite stacks. In particular, they have shown improved balance between VLT and TSER transmission.

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

1.-15. (canceled)

16. A composite window film comprising:
a first window facing substrate;
a reflecting stack; and
an absorbing stack,
wherein the reflecting stack is located between the first window facing substrate and the absorbing stack,
wherein the composite window film has a VLT of not greater than about 80%,
wherein the composite window film has a TSER of at least about 40%, and
wherein the composite window film has an Energetic Absorption (EA) of not greater than about 50%.

17. The composite window film of claim 16, wherein the functional layer comprises silver, gold, aluminum, copper, stainless steel, alloys thereof or combinations thereof.

18. The composite window film of claim 16, wherein the functional layer consists of silver, gold, aluminum, copper, stainless steel, alloys thereof or combinations thereof.

19. The composite window film of claim 16, wherein the absorbing stack comprises a metal nitride, a transparent conductive oxide (TCO), Nb, NbN, NiCrN, MoN, NiₓCR_{y}Nb_{z}, NiₓCR_{y}Nb_{z}N_{α}, GZO or AZO.

20. The composite window film of claim 16, wherein the absorbing stack consists of a metal nitride, a transparent conductive oxide (TCO), Nb, NbN, NiCrN, MoN, NiₓCR_{y}Nb_{z}, NiₓCR_{y}Nb_{z}N_{α}, GZO or AZO.

21. The composite window film of claim 16, wherein the absorbing stack comprises a first absorbing stack dielectric layer and a second absorbing stack dielectric layer.

22. The composite window film of claim 21, wherein the absorber layer is located between the first absorbing stack dielectric layer and the second absorbing stack dielectric layer.

23. The composite window film of claim 21, wherein the first absorbing stack dielectric layer and the second absorbing stack dielectric layers each comprise TiO_{X}, NbO_{X}, Si₃N₄, SiZrN, SnZnOx, SiOx, ZnOx, InOx, SnO₂, BiO2, PbO, GZO, AZO, ITO, MgZnO, MgO, MoO3, ZrOx or AlOx.

24. The composite window film of claim 16, wherein the reflecting stack further comprises a first blocker layer and a second blocker layer.

25. The composite window film of claim 24, wherein the functional layer is located between the first blocker layer and the second blocker layer.

26. The composite window film of claim 24, wherein the functional layer is located between the first blocker layer and the second blocker layer.

27. The composite window film of claim 24, wherein the first blocker layer and the second blocker layer each comprise Ti, Cu, Ni, Cr, Pt, Au, Pd, Nb, NiCr, oxides thereof, alloys thereof or combinations thereof.

28. The composite window film of claim 24, wherein the first blocker layer and the second blocker layer each consist of Ti, Cu, Ni, Cr, Pt, Au, Pd, Nb, NiCr, oxides thereof, alloys thereof or combinations thereof.

29. A composite window film comprising:
a first substrate having a first surface and a second surface opposite of and spaced away from the first surface;
a pressure sensitive adhesive layer disposed on the first surface of the first substrate;
a reflecting stack comprising a functional layer, wherein the functional layer comprises silver, gold, aluminum, copper, stainless steel, alloys thereof or combinations thereof; and
an absorbing stack comprising an absorber layer, wherein the absorber layer comprises a metal nitride, a transparent conductive oxide (TCO), NbN, NiCrN, MoN, GZO or AZO,
wherein the first substrate is located between the pressure sensitive adhesive layer and the reflecting stack, and
wherein the reflecting stack is located between the first substrate and the absorbing stack.

30. The composite window film of claim 29, wherein the functional layer comprises silver, gold, aluminum, copper, stainless steel, alloys thereof or combinations thereof.

31. The composite window film of claim 29, wherein the functional layer consists of silver, gold, aluminum, copper, stainless steel, alloys thereof or combinations thereof.

32. The composite window film of claim 29, wherein the absorbing stack comprises a metal nitride, a transparent conductive oxide (TCO), Nb, NbN, NiCrN, MoN, NiₓCR_{y}Nb_{z}, NiₓCR_{y}Nb_{z}N_{α}, GZO or AZO.

33. The composite window film of claim 29, wherein the absorbing stack consists of a metal nitride, a transparent conductive oxide (TCO), Nb, NbN, NiCrN, MoN, NiₓCR_{y}Nb_{z}, NiₓCR_{y}Nb_{z}N_{α}, GZO or AZO.

34. The composite window film of claim 29, wherein the absorbing stack comprises a first absorbing stack dielectric layer and a second absorbing stack dielectric layer.

35. A method of forming a window film, wherein the method comprises:
providing an absorbing stack;
forming a reflecting stack over the absorbing stack; and
forming a first window facing substrate over the reflecting stack,
wherein the composite window film has a VLT of not greater than about 80%,
wherein the composite window film has a TSER of at least about 40%, and
wherein the composite window film has an Energetic Absorption (EA) of not greater than about 50%.
